(19) United States
(12) Patent Application Publication
(10) Pub. No.: US 2005/0132330 A1
(43) Pub. Date: Jun. 16, 2005

(54) Method, system and program product for tracking data

(75) Inventor: Jonathan T. Zempel, Campbell, CA (US)

Correspondence Address: HOFFMAN, WARNICK & D'ALESSANDRO LLC, THREE E-COMM SQUARE, ALBANY, NY, 12207, US

(73) Assignee: International Business Machines Corporation, Armonk, NY (US)

(21) Appl. No.: 10/734,038

(22) Filed: Dec. 11, 2003

(51) Int. Cl. G06F 9/44

(52) U.S. Cl. 717/120; 717/116; 717/165

(57) ABSTRACT

An improved solution for tracking data wherein communication between an interface and a data application is managed by a pluggable tracking system. In particular, the tracking system is configured to receives a request from the interface, provides the necessary information from the request to the data application, and receives response data from the data application. The tracking system then formats the response data appropriately and forwards a response to the interface. The tracking system can incorporate a set standard for communicating with data applications, thereby allowing multiple data applications to use the same tracking system.

### BACKGROUND OF THE INVENTION

1. Technical Field

The invention relates generally to tracking data, and more specifically to a method, system and program product that provide an interface for tracking data apart from any particular data application.

2. Background Art

Many applications track data that is read and/or written by a particular user during execution. For example, electronic learning applications frequently track learning content, such as lessons accessed, testing answers, content accessed, etc. during each execution. Further, attributes of the data access such as the time that the data was accessed may also be stored as tracked data. The tracked data can then be used to evaluate the application and/or the user. For example, in the case of an electronic learning application, a student's progress can be evaluated.

Currently, data tracking is implemented as part of the data application. In this case, internal data representations and/or functions are often accessed in order to implement the data tracking. For example, a learning management system (LMS) typically includes functionality for tracking data, which accesses the database schema, learning logic, etc. of the LMS in order to generate/process messages to/from each student. As a result, each data tracking implementation is unique due to the differences in each data application. Further, any change to the internal data representations and/or functions of the data application may require a change to the data tracking implementation.

When multiple data applications track data using a common communication format, it is inefficient to reimplement the data tracking for each data application. For example, in electronic learning applications, various standards for communicating tracked data have been developed. These include, for example, the Aviation Industry Computer Based Training (CBT) Committee's (AICC) Computer Managed Instruction (CMI) protocol, its associated HyperText Transfer Protocol (HTTP)-based protocol (HACP), and Advanced Distributed Learning's (ADL™) Sharable Content Object Reference Model (SCORM™) Runtime Environment (RTE). Currently, when multiple data applications support the same standard (e.g., HACP), the data tracking functionality is independently implemented in each data application. Further, when a data application, such as International Business Machine's (IBM) eLearning Tracking Module™, seeks to support multiple standards, each data tracking implementation will access the internal data representations and/or functions, introducing multiple sources for potential errors.

As a result, a need exists for a method, system, and program product that provide a pluggable n interface for tracking data apart from any particular data application.

### SUMMARY OF THE INVENTION

The invention provides a solution for communicating tracking data apart from a data application. In particular, a tracking system can manage communications between a data application and an interface. The tracking system can manage data required for tracking, and provide the necessary data to the data application in response to a request received from the interface. The data application can generate response data, and provide the response data to the tracking system. The tracking system can then format the response data appropriately and provide a response to the request to the interface. The tracking system can incorporate a set standard for communicating with data applications. As a result, the invention provides support for one or more predefined data tracking standards to the data application without requiring any modification to the data application and/or any knowledge of the internal data representations and/or functions of the data application. Further, the invention provides a tracking system that can enable data applications to support various data tracking standards while using a single standard for communicating with the tracking system.

A first aspect of the invention provides a method of tracking data, the method comprising: receiving a request from a client, wherein the request includes a tracked data item; selecting a handler based on the tracked data item; obtaining response data from a data application based on the tracked data item; and generating a response based on the response data using the handler.

A second aspect of the invention provides a method of tracking data, the method comprising: receiving a request from a client, wherein the request includes a tracked data item; selecting a handler based on the tracked data item and the client; obtaining response data for the tracked data item from a data application; generating a response based on the response data using the handler; and providing the response to the client.

A third aspect of the invention provides a system for tracking data, the system comprising: at least one handler for processing a request that includes a tracked data item; and a management system for receiving the request from a client and selecting one of the at least one handlers based on the request; wherein the selected handler obtains response data for the tracked data item and generates a response based on the response data.

A fourth aspect of the invention provides a program product stored on a recordable medium for tracking data, which when executed comprises: program code for receiving a request from a client, wherein the request includes a tracked data item; program code for selecting a handler based on the tracked data item and the client; program code for obtaining response data for the tracked data item from a data application; program code for generating a response based on the response data using the handler; and program code for providing the response to the client.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for tracking data; and

FIG. 2 shows an illustrative data flow for the system shown in FIG. 1.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a solution for communicating tracking data apart from a data application. In particular, a tracking system can manage communications between a data application and an interface. The tracking system can manage data required for tracking, and provide the necessary data to the data application in response to a request received from the interface. The data application can generate response data, and provide the response data to the tracking system. The tracking system can then format the response data appropriately and provide a response to the request to the interface. The tracking system can incorporate a set standard for communicating with data applications. As a result, the invention provides support for one or more predefined data tracking standards to the data application without requiring any modification to the data application and/or any knowledge of the internal data representations and/or functions of the data application. Further, the invention provides a tracking system that can enable data applications to support various data tracking standards while using a single standard for communicating with the tracking system.

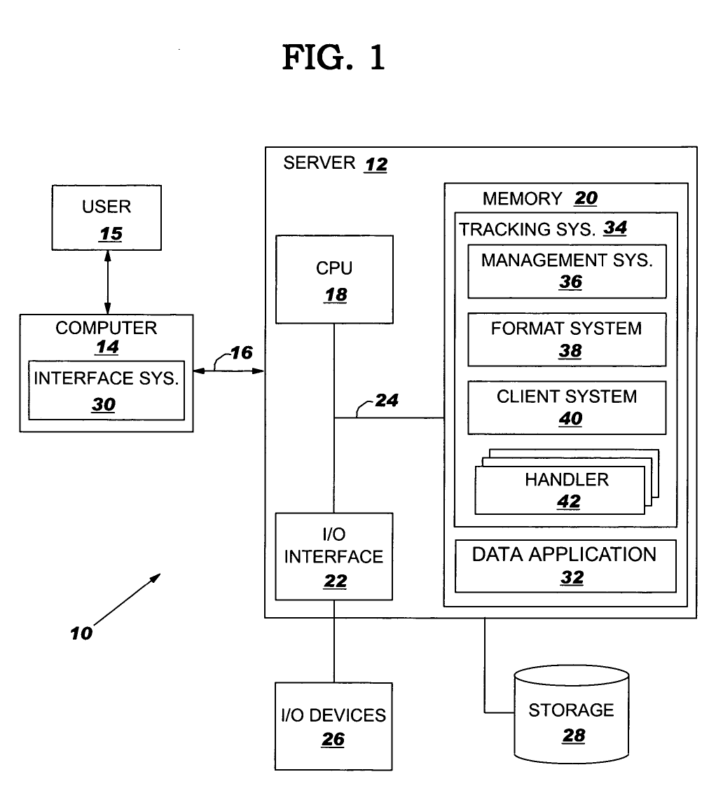

Turning to the drawings, FIG. 1 shows an illustrative system 10 for tracking data. In particular, a user 15 can operate an interface system 30 on computer 14 to use a data application 32 stored on a server 12. Interface system 30 can comprise any type of system for displaying information to user 15 and allowing user 15 to request and/or provide information to data application 32. To this extent, during use, messages can be communicated between interface system 30 and data application 32 over a network 16. Network 16 can comprise any type of communications link. For example, network 16 can comprise an addressable connection in a client-server (or server-server) environment that may utilize any combination of wireline and/or wireless transmission methods. In this instance, server 12 and computer 14 may utilize conventional network connectivity, such as Token Ring, Ethernet, WiFi or other conventional communications standards. Further, network 16 can comprise any type of network, including the Internet, a wide area network (WAN), a local area network (LAN), a virtual private network (VPN), etc. Where server 12 and computer 14 communicate via the Internet, connectivity could be provided by conventional TCP/IP sockets-based protocol, and computer 14 could utilize an Internet service provider to establish connectivity.

As shown, server 12 generally includes a central processing unit (CPU) 18, a memory 20, an input/output (I/O) interface 22, a bus 24, external I/O devices/resources 26, and a storage unit 28. CPU 18 may comprise a single processing unit, or be distributed across one or more processing units in one or more locations, e.g., on a client and server. Memory 20 may comprise any known type of data storage and/or transmission media, including magnetic media, optical media, random access memory (RAM), read-only memory (ROM), a data cache, a data object, etc. Storage unit 28 may comprise any type of data storage for providing storage for information necessary to carry out the invention as described below. As such, storage unit 28 may include one or more storage devices, such as a magnetic disk drive or an optical disk drive. Moreover, similar to CPU 18, memory 20 and/or storage unit 28 may reside at a single physical location, comprising one or more types of data storage, or be distributed across a plurality of physical systems in various forms. Further, memory 20 and/or storage unit 28 can include data distributed across, for example, a LAN, a WAN or a storage area network (SAN) (not shown).

I/O interface 22 may comprise any system for exchanging information to/from one or more external I/O devices 26. I/O devices 26 may comprise any known type of external device, including speakers, a CRT, LED screen, handheld device, keyboard, mouse, voice recognition system, speech output system, printer, monitor/display, facsimile, pager, communication hardware/software, etc. Bus 24 provides a communication link between each of the components in server 12 and likewise may comprise any known type of transmission link, including electrical, optical, wireless, etc. In addition, although not shown, additional components, such as system software, may be incorporated into server 12.

It is understood that computer 14 typically includes the same elements as shown in server 12 (e.g., CPU, memory, I/O interface, etc.). These have not been separately shown and discussed for brevity. Further, it is understood that server 12 and computer 14 each comprise any type of computing device capable of communicating with one or more other computing devices, such as a server, a desktop computer, a laptop, a handheld device, a mobile phone, a pager, a personal data assistant, etc. However, it is understood that if, for example, computer 14 is a handheld device or the like, a display could be contained within the computer 14, and not as an external I/O device 26 as shown for server 12.

As noted previously, system 10 tracks some or all of the data communicated between data application 32 and interface system 30 and/or one or more attributes of the data communications (e.g., time of communication). To this extent, server 12 is shown including a tracking system 34 for tracking data. Tracking system 34 formats and decodes communications to/from data application 32. The communications can be formatted to conform to a predefined tracking standard. Further, tracking system 34 can maintain data required for implementing the data tracking functionality apart from data application 32.

In one embodiment, tracking system 34 includes a management system 36 for receiving a request from interface system 30. Management system 36 can select one of a set (one or more) of handlers 42 for processing the request (as will be further described below). In particular, the selected handler 42 can generate a response that can be provided to interface system 30. Interface system 30 can process the response and display any changes to user 15. In order to generate the response, handler 42 can obtain response data from data application 32. The response data can be based on, for example, one or more tracked data items included in the request as discussed in more detail below.

Further, tracking system 34 can include a format system 38 for providing format data and/or a client system 40 for providing client data to handler 42 for use in formatting the response. The format data can be based on a predefined tracking standard, while the client data can be based on a “client.” As used herein, client refers to computer 14, user 15, or both computer 14 and user 15. For example, a request can include a tracking type identifier and a session identifier. The tracking type identifier can be used to obtain format data from format system 38, while the session identifier could be used to obtain client data from client system 40. The format data and/or client data can then be used in formatting the response. While tracking system 34 and data application 32 are both shown implemented on server 12, it is understood that some or all of tracking system 34 could be implemented on another computing system in communication with server 12 and computer 14.

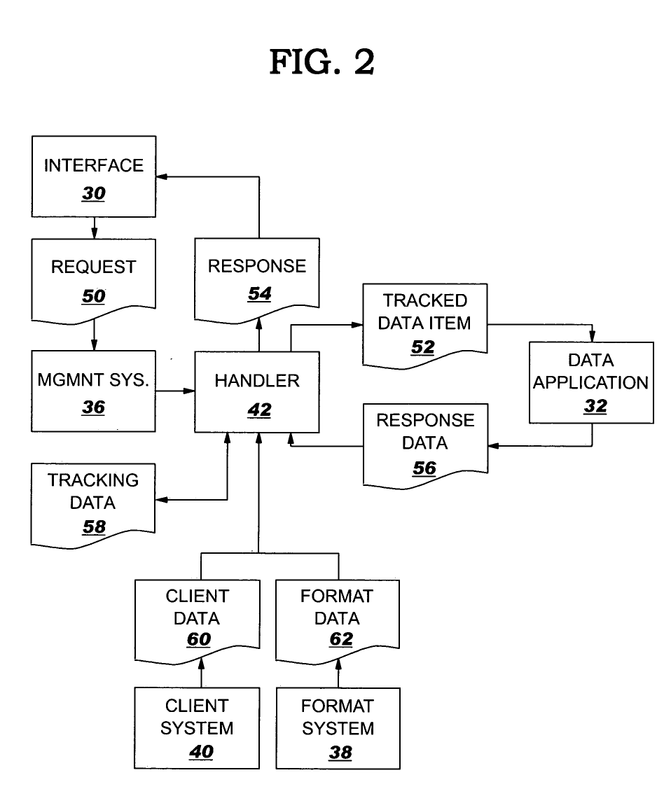

FIG. 2 shows an illustrative data flow between the various systems shown in FIG. 1 according to one embodiment of the invention. In particular, interface system 30 can send a request 50 to data application 32. Interface system 30 can comprise any type of system for allowing a user 15 (FIG. 1) to interact with data application 32. For example, interface system 30 can comprise a custom software application, a browser, or the like. When interface system 30 comprises a browser, one or more “plug-ins” could be included to provide additional functionality that may be used by data application 32. Interface system 30 can send request 50 in response to an operation performed by user 15, automatically after a predetermined amount of time, to initialize a display for user 15, or the like.

In any event, management system 36 can receive request 50 on server 12, and can select a handler 42 for processing request 50. For example, request 50 can identify one or more data items for which data is being provided and/or data is being requested. Each handler 42 can process a particular data item, a particular subset of data items, or the like. Further, request 50 could identify the client. Similarly, handler 42 can be selected based on a particular client, group of clients, etc. Still further, each handler 42 can be selected based on both the data item(s) and the client. In any event, management system 36 can select handler 42 based on request 50 and/or the client, and can forward request 50 to the selected handler 42 for processing.

One or more of the data items included in request 50 can can comprise a tracked data item 52. Each tracked data item 52 can comprise any type of data item. For example, tracked data item 52 can comprise a temperature reading, a test answer, a lesson in a course, etc. In one embodiment, request 50 can include an identifier and/or a value for tracked data item 52. Handler 42 can obtain additional data regarding tracked data item 52 from tracking data 58 that can be stored in, for example, storage unit 28 (FIG. 1). Handler 42 can separately maintain tracking data 58 for each tracked data item 52 and/or client. For example, when a request 50 is received that includes data for a tracked data item 52, handler 42 can add/update an entry in tracked data 58 that corresponds to tracked data item 52 and/or the client. Further, handler 42 can update tracking data 58 based on response data 56 received from data application 32. In any event, tracking data 58 can be maintained by handler 42, and can be used to generate response 54.

To this extent, tracked data item 52 can include an associated trackable object. The trackable object can comprise data required for the tracked data item 52. For example, in electronic learning applications, the trackable object can comprise progress, mastery, objectives, etc. for a particular tracked data item 52. Further, a unique trackable object can be stored for each combination of tracked data item 52 and client. In this case, handler 42 can obtain the trackable object based on the client and tracked data item 52 identified in request 50 from tracking data 58. A trackable data item 52 can also have one or more measurable objectives associated with it. A measurable objective can comprise data that defines an objective for the associated tracked data item 52. For example, a measurable objective could comprise a scoring level, a minimum/maximum score, or the like. Handler 42 can also obtain the measurable objective(s) from tracking data 58 based on the client and tracked data item 52.

Handler 42 can generate a response 54 to request 50, and provide response 54 back to the client (e.g., interface 30). In order to generate response 54, handler 42 can obtain response data 56 from data application 32. In one embodiment, handler 42 can provide tracked data item 52 received in request 50 to data application 32, which can generate response data 56 based on tracked data item 52. In particular, data application 32 may access and/or update data stored in, for example, storage unit 28, perform one or more calculations, etc. Further, handler 42 can provide a measurable objective(s) and/or a trackable object associated with tracked data item 52 to data application 32 as discussed above. Data application 32 can use trackable object and/or measurable objective(s) in order to generate response data 56 for tracked data item 52. Still further, client system 40 could provide client data 60 to handler 42 based on a client identifier (e.g., session identifier) or the like. Handler 42 can also provide data application 32 with client data 60 for generating response data 56. As noted previously, handler 42 can communicate with data application 32 using a set standard. For example, handler 42 can send messages to data application 32 that include a trackable object and one or more measurable objectives, and data application 32 can provide response data 56 formatted as text. In any event, once response data 56 has been generated, data application 32 can provide response data 56 to handler 42.

When generating response 54, handler 42 can format response data 56 into a response format. In one embodiment, format system 38 provides handler 42 with format data 62. Format data 62 can define a particular response format that handler 42 is to follow. Format data 62 can be based on, for example, a predefined tracking communication standard such as CMI protocol, HACP, SCORM, or the like. Further, response data 56 can be formatted based on the client. To this extent, client system 40 can provide client data 60 to handler 42 for formatting response data 56. Client data 60 can comprise, for example, display preferences or the like for the client.

Once response 54 has been generated, handler 42 can provide response 54 to interface system 30. Interface system 30 processes response 54 in a known fashion. As a result, the invention provides a new solution that allows the various implementation details for communicating tracked data to be implemented apart from a data application 32. Consequently, data application 32 can be modified without impacting data tracking, and tracking system 34 can be modified without impacting data application 32. Further, support for different and/or additional predefined tracking standards can be implemented without modifying data application 32. In this manner, tracking system 34 can be used in conjunction with any type of data application 32, thereby providing data tracking functionality to data application 32.

It is understood that the present invention can be realized in hardware, software, or a combination of hardware and software. Any kind of computer/server system(s), or other apparatus adapted for carrying out the methods described herein—is suited. A typical combination of hardware and software could be a general-purpose computer system with a computer program that, when loaded and executed, carries out the respective methods described herein. Alternatively, a specific use computer (e.g., a finite state machine), containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method of tracking data, the method comprising:
receiving a request from a client, wherein the request includes a tracked data item;
selecting a handler based on the tracked data item;
obtaining response data from a data application based on the tracked data item; and
generating a response based on the response data using the handler.

2. The method of claim 1, further comprising providing the response to the client.

3. The method of claim 1, wherein the selecting step is further based on the client.

4. The method of claim 1, wherein the obtaining step includes:
retrieving a trackable object associated with the tracked data item; and
providing the trackable object to the data application.

5. The method of claim 1, wherein the obtaining step includes:
retrieving at least one measurable objective associated with the tracked data item; and
providing the at least one measurable objective to the data application.

6. The method of claim 1, wherein the generating step includes:
obtaining format data based on a response format; and
formatting the response data using the format data.

7. The method of claim 6, wherein the format data defines a predefined tracking standard.

8. The method of claim 1, wherein the generating step includes:
obtaining client data based on the client; and
formatting the response data using the client data.

9. A method of tracking data, the method comprising:
receiving a request from a client, wherein the request includes a tracked data item;
selecting a handler based on the tracked data item and the client;
obtaining response data for the tracked data item from a data application;
generating a response based on the response data using the handler; and
providing the response to the client.

10. The method of claim 9, wherein the obtaining step includes:
retrieving a trackable object associated with the tracked data item; and
providing the trackable object to the data application.

11. The method of claim 9, wherein the obtaining step includes:
retrieving at least one measurable objective associated with the tracked data item; and
providing the at least one measurable objective to the data application.

12. The method of claim 9, wherein the generating step includes:
obtaining format data based on a response format; and
formatting the response data using the format data.

13. The method of claim 12, further comprising obtaining client data based on the client, wherein the formatting step further uses the client data.

14. A system for tracking data, the system comprising:
at least one handler for processing a request that includes a tracked data item; and
a management system for receiving the request from a client and selecting one of the at least one handlers based on the request;
wherein the selected handler obtains response data for the tracked data item and generates a response based on the response data.

15. The system of claim 14, further comprising a data application for providing the response data to the selected handler.

16. The system of claim 14, further comprising a client system for providing client data based on the client.

17. The system of claim 14, further comprising a format system for providing format data based on a predefined tracking standard.

18. A program product stored on a recordable medium for tracking data, which when executed comprises:
program code for receiving a request from a client, wherein the request includes a tracked data item;
program code for selecting a handler based on the tracked data item and the client;
program code for obtaining response data for the tracked data item from a data application;
program code for generating a response based on the response data using the handler; and
program code for providing the response to the client.

19. The program product of claim 18, further comprising:
program code for retrieving at least one of: a trackable object and at least one measurable objective associated with the tracked data item; and
program code for providing the at least one of: a trackable object and at least one measurable objective to the data application.

20. The program product of claim 18, further comprising:
program code for obtaining format data based on a response format;
program code for obtaining client data based on the client; and
program code for formatting the response data using the format data and the client data.
